(19) United States
(12) Patent Application Publication
(10) Pub. No.: US 2004/0085204 A1
(43) Pub. Date: May 6, 2004

(54) On command music playing beverage holder

(76) Inventor: Thomas Allen Ogle, Clearwater, FL (US)

Correspondence Address: Dennis G. LaPointe, Esq., Mason Law, P.A., Suite 500, 17757 U.S. Hwy. 19 N., Clearwater, FL, 33764, US

(21) Appl. No.: 10/637,338

(22) Filed: Aug. 8, 2003

Related U.S. Application Data
(60) Provisional application No. 60/420,856, filed on Oct. 24, 2002.

(51) Int. Cl. G08B 1/08

(52) U.S. Cl. 340/539.32; 340/573.1; 340/692

(57) ABSTRACT

An insulated foam beverage holder, which plays music for either location or entertainment purposes. The top portion of the container contains an industry standard flexible foam sleeve. This foam sleeve is slightly larger than a 12-ounce beverage so as to allow a standard 12 oz. or 16 oz. beverage to fit snug. The sleeve also provides for an area to be used for indicia to correspond with desired music themes. The upper portion of the foam sleeve is fused to the molded plastic base module. This plastic base module contains the mechanisms for the operation of the music. The holder plays music by either clapping (or any distinct noise) or pressure upon the base. Activation is done with pressure sensors or sound sensors.

### RELATED APPLICATIONS

This application claims the benefit of earlier filed U.S. Provisional Application Ser. No. 60/420,856 filed Oct. 24, 2002, which claimed the benefit of earlier filed U.S. application Ser. No. 10/106,966 filed Mar. 28, 2002, now abandoned.

### FIELD OF THE INVENTION

This invention relates to an insulated beverage holder of the type adapted to thermally insulate a beverage and play music upon command, through either a sound activated sensor or a pressure sensor.

### BACKGROUND

As mentioned above, this invention relates to an insulated beverage holder of the type adapted to thermally insulate a beverage and play music upon command, through either a sound activated sensor or a pressure sensor. Typical insulated beverage holders can hold cans or bottles. The principle of this invention is for either the location of an individual's beverage preferably combined with the entertainment of hearing a desired song/hymn/jingle. This invention does not attempt to lay claim to any of the multiple and various processes by which insulated beverage holders are produced. Contrastly, this invention utilizes these products as a raw material and adds a plastic base module to produce an interactive thermal insulated beverage holder. There does seem to be an instance in which a base module has been used for such a thing as housing refrigerant to keep a beverage cold. However, this invention utilizes a plastic base module in a markedly different manner and for a distinctly different purpose.

### SUMMARY OF THE INVENTION

This invention provides for a unique and novel approach to the location of a beverage, via the mechanisms installed in the container's plastic base module. Furthermore, the beverage holder also provides for entertainment and promotional ability by playing proprietary music that can be associated with a variety of institutions (educational, corporate, team). The entertainment aspect industry standard production techniques a thermally insulated beverage holder is fashioned from a moldable plastic material, the holder being in the general form of an open ended cylinder which is fused at the bottom to a plastic module. This insulating receptacle is lightweight, simple in construction, and insulates from heat exchange. Foam sleeves, insulated fabric materials and insulated metallic or plastic based sleeves are typically used for such holder sleeves.

### BRIEF DESCRIPTION OF THE DRAWING

FIG. 1 is an exploded schematic representation of an example of the various components of the present invention.

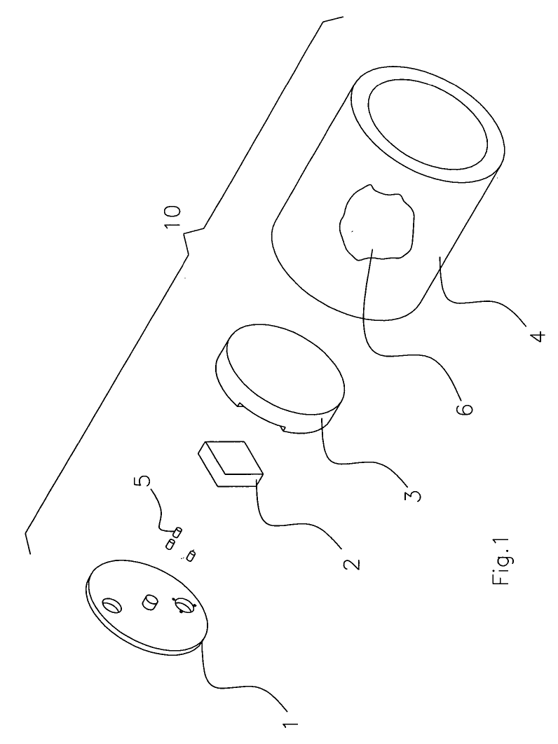

### DESCRIPTION OF THE INVENTION

Referring now to the drawing wherein the invention is generally depicted in combination as 10, 4 generally refers to the foam sleeve of the thermally insulated beverage beverage holder of this invention. It is typically formed and molded using various industrial moldable materials, including foam, and has a cylindrical shell. Alternatively, such sleeves 4 can be made from insulated fabric material or insulated metallic or plastic based materials as well. For example purposes only, a foam sleeve is shown in the drawing. This cylindrical shell or sleeve 4 can be fused to the top or base 3 using generally accepted heat and/or glue fusion technologies, such as when foam is used for the sleeve. Similarly, when the sleeves are made from other materials, fixation methods of the sleeves 4 to the base 3 are known in the art, for example, other adhesive methods or combination sewing and adhesive when fabric material is used for the sleeve 4. The inside bore of sleeve 4 is sized to receive a beverage (can or bottle) of the usual 12 oz. or 16 oz. size. The outside shell of sleeve 4 provides a surface area for indicia 6 which is used to promote in tandem any proprietary indicia 6 in respect to the music being played by the sound box 2 that lies therein.

The manufacturing of the base module shell, which comprises the top or base 3 and bottom or cover 1, can be produced by using a plastic injection mold to render the final empty shell for the placement of the operational mechanisms. The bottom a mold would have small openings (not shown) to allow for air to escape when pressure is applied to the pressure sensor inside the sound box 2 and to allow sound to travel freely within the base module for activation of the sound sensor. The pins 5, which signal that pressure is being applied to the sound box 2 run from the bottom of cover 1 into the bottom section of base 3 and complete a circuit allowing an electrical impulse to pass through to signal the Sound Box 2 to play its programmed song.

The Sound Box 2 is another item, which is procured through a vendor and is a single unit raw material in the production of this invention. The Sound Box 2 itself contains a small computer chip, which is programmed with a song/hymn/jingle and connected to a small battery for its electrical source. Its internal circuitry consists of the routing of electrical impulses powering the Sound Box 2, and completing the circuits of the sound sensor and the pressure sensor to alert the Sound Box of any command to play. Furthermore, the Sound Box 2 fits within a predetermined section of the plastic base module to allow for maximum durability and protection.

The operation of this Invention is based upon two principles. The first principle of this Invention's activation is sound. This is the Invention's primary claim and novelty. The sound must be that of a loud noise, with a distinct start and finish (for example, a clap). Many commercial devices have been produced using such a method and work rather reliably. It is through this sound activation that an individual is able to locate their beverage when misplaced or play the programmed song/hymn/jingle for their amusement. The second principle of this Invention's activation is pressure. Through the exertion of pressure upon the bottom cover 1 of the plastic base module, the Pins 5 complete a circuit within the Sound Box 2 and allows for the programmed music to be played upon direct command. The novelty of such a principle is to allow an individual to play the programmed music for their own or others pleasure in respect to any situation, albeit social and/or business, to promote, show pride, or demonstrate the function of the invention. This invention is a novel and unique approach on two different levels. First, it provides for a new and unique way to locate ones beverage when it is lost using music on sound command. Second, it provides for novel advertising and marketing venues to promote the sale of the beverage containers. This can be done with both proprietary music and indicia 6, marqueed in tandem or individually. The foregoing is considered as illustrative only of the principles of the invention. Furthermore, since numerous modifications and changes will readily occur to those skilled in the art, it is not desired to limit the Invention to the exact construction and operation shown and described, accordingly, all suitable modifications and equivalents may be resorted to falling within the scope of this invention as claimed.

I claim:

1. A thermally insulated beverage holder, including a sleeve into which the beverage can is insertable, comprising, in combination:
a pressure sensitive base, connected via pressure pins, housed within a plastic module, and connected to a Sound Box;
a sound activated sensor connected to a Sound Box;
the Sound Box having pre-programmed means for the playback of predetermined songs/hymns/jingles.

2. The thermally insulated beverage holder according to claim 1, wherein the Sound Box is activated by one of distinct noise sensor means, pressure sensor means upon the base, and a combination thereof.

3. The thermally insulated beverage holder according to claim 2, wherein the Sound Box, pressure sensor means, and noise sensor means is mounted within a plastic base module and in electrical communication with a source of electrical power.

4. The thermally insulated beverage holder according to claim 1, further comprising indicia located on an outside surface of the sleeve, said indicia to be used in tandem with the predetermined songs/hymns/jingles to be played by the Sound Box contained within the base module.
